(19) United States
(12) Patent Application Publication
(10) Pub. No.: US 2026/0341233 A1
(43) Pub. Date: Oct. 29, 2026

(54) DISPLAY DEVICE AND DRIVING METHOD THEREOF

(71) Applicant: LG Display Co., Ltd., Seoul (KR)

(72) Inventors: Seung Jin YOO, Paju-si (KR); Sang Jin NAM, Paju-si (KR); Hyun Gi HONG, Paju-si (KR)

(73) Assignee: LG Display Co., Ltd., Seoul (KR)

(21) Appl. No.: 19/558,769

(22) Filed: Mar. 6, 2026

(30) Foreign Application Priority Data
Apr. 29, 2025 (KR) 10-2025-0055968

(51) Int. Cl. G09G 3/3275; G09G 3/32; G09G 3/3266

(52) U.S. Cl. CPC G09G 3/3275; G09G 3/32; G09G 3/3266; G09G 2300/0819; G09G 2310/0245; G09G 2310/0267; G09G 2310/0275; G09G 2330/021

(57) ABSTRACT

A display device and a driving method thereof are discussed. The display device includes a display panel in which a plurality of data lines, a plurality of gate lines, a plurality of power lines, at least one selection line, and a plurality of pixels are disposed, a data driver electrically connected to the data lines, a gate driver that is electrically connected to the gate lines, and a selector configured to supply a selection signal to the selection line. A display area of the display panel is divided into a plurality of pixel areas that are driven at different frequencies according to a voltage of the selection signal.

### CROSS-REFERENCE TO RELATED APPLICATION

This application claims priority to and the benefit of Korean Patent Application No. 10-2025-0055968, filed in the Republic of Korea on Apr. 29, 2025, the disclosure of which is hereby expressly incorporated by reference in its entirety.

### BACKGROUND

### Field

The present disclosure relates to a display device that supports a variable refresh rate (VRR) and a driving method thereof.

### Discussion of the Related Art

Various flat panel displays such as a liquid crystal display and an electroluminescence display are known. The electroluminescence display can use light-emitting elements provided in each of pixels to emit light by itself without a backlight and can display an input image. The light-emitting elements of the electroluminescence display can be divided into organic light-emitting elements and inorganic light-emitting elements depending on a material for a light-emitting layer. An active matrix type electroluminescence display has advantages of a high response speed, high light emission efficiency, high luminance, and a wide viewing angle since an organic light emitting diode (hereinafter, referred to as an "OLED") is provided in each pixel, and is excellent in contrast ratio and color reproducibility since a black grayscale can be expressed as complete black.

Recently, the display device supports a variable refresh rate (VRR). According to the technique of the variable refresh rate, while power consumption can be reduced, the refresh rate is not freely controlled within a screen.

### SUMMARY OF THE DISCLOSURE

Embodiments of the present disclosure address the above-described shortcomings and/or problems associated with the related art.

The problems addressed by the present disclosure are not limited to those described above, and other problems not described will be clearly understood by those skilled in the art from the following description.

A display device according to one embodiment of the present disclosure includes a display panel in which a plurality of data lines, a plurality of gate lines, a plurality of power lines, at least one selection line, and a plurality of pixels are disposed; a data driver electrically connected to the data lines; a gate driver electrically connected to the gate lines; and a selector configured to supply a selection signal to the selection line. A display area of the display panel is divided into a plurality of pixel areas that are driven at different frequencies in a first direction according to a voltage of the selection signal.

According to aspects of the present disclosure, the gate driver can supply a plurality of gate signals having different waveforms in the respective pixels to the gate lines. The display area of the display panel can be divided into a plurality of pixel areas that are driven at different frequencies in a second direction according to a voltage of at least one gate signal among the gate signals. The second direction can intersect the first direction.

According to aspects of the present disclosure, each of the pixels can include a plurality of sub-pixels. Each of the sub-pixels can include a light-emitting element; a driving element configured to drive the light-emitting element; a capacitor connected to the driving element; and at least one switch element that is connected to the capacitor or is electrically separated from the capacitor in response to the selection signal.

According to aspects of the present disclosure, each of the sub-pixels can include a light-emitting element; a driving element configured to drive the light-emitting element; a capacitor connected to the driving element; a first-first switch element that is controlled according to the voltage of the selection signal; and a first-second switch element that is connected in series to the first-first switch element and is controlled according to a voltage of at least one gate signal among the gate signals.

According to aspects of the present disclosure, each of the sub-pixels can include a driving transistor including a gate electrode connected to a first node, a first electrode connected to a second node, and a second electrode connected to a third node; a capacitor connected between a first power line and the first node; a light-emitting element including an anode electrode connected to a fourth node and a cathode electrode connected to a second power line; a first-first switch transistor that is connected between the first node and the third node, and is turned on in response to a gate on voltage of the selection signal and turned off in response to a gate off voltage of the selection signal; a first-second switch transistor that is connected between the first-first switch transistor and the third node, and is turned on in response to a gate on voltage of a first gate signal and turned off in response to a gate off voltage of the first gate signal; a second-first switch transistor that is connected between the first node and a fifth power line to which an initialization voltage is applied, and is turned on in response to a gate on voltage of the selection signal and turned off in response to a gate off voltage of the selection signal; and a second-second switch transistor that is connected between the second-first switch transistor and the fifth power line, and is turned on in response to the gate on voltage of the first gate signal and turned off in response to the gate off voltage of the first gate signal.

According to aspects of the present disclosure, each of the sub-pixels can further include a third switch transistor that is connected between the first power line and the second node, and is turned on in response to a gate on voltage of a fifth gate signal; a fourth switch transistor that is connected between the third node and the fourth node, and is turned on in response to the gate on voltage of the fifth gate signal; a fifth switch transistor that is connected between the second node and the third power line, and is turned on in response to a gate on voltage of a third gate signal; a sixth switch transistor that is connected between the fourth node and a fourth power line, and is turned on in response to the gate on voltage of the third gate signal; and a seventh switch transistor that is connected between the data line and the second node, and is turned on in response to a gate on voltage of a second gate signal.

According to aspects of the present disclosure, each of the sub-pixels can include a driving transistor including a gate electrode connected to a first node, a first electrode connected to a second node, and a second electrode connected to a third node; a capacitor connected between a first power line and the first node; a light-emitting element including an anode electrode connected to a fourth node and a cathode electrode connected to a second power line; a first-first switch transistor that is connected between the first node and the third node, and is turned on in response to a gate on voltage of the selection signal and turned off in response to a gate off voltage of the selection signal; a first-second switch transistor that is connected between the first-first switch transistor and the third node, and is turned on in response to a gate on voltage of a first gate signal and turned off in response to a gate off voltage of the first gate signal; a second-first switch transistor that is connected between the first node and a fifth power line to which an initialization voltage is applied, and is turned on in response to the gate on voltage of the selection signal and turned off in response to the gate off voltage of the selection signal; a second switch transistor that is connected between the data line and the second node, and is turned on in response to a gate on voltage of a second gate signal; a third switch transistor that is connected between the first power line and the second node, and is turned on in response to a gate on voltage of a fourth gate signal; a fourth switch transistor that is connected between the third node and a fourth node, and is turned on in response to the gate on voltage of the fourth gate signal; a fifth switch transistor that is connected between the third node and a third power line, and is turned on in response to a gate on voltage of a third gate signal; and a sixth switch transistor that is connected between the fourth node and a fourth power line, and is turned on in response to the gate on voltage of the third gate signal.

According to aspects of the present disclosure, a non-display area of the display panel can include a dummy gate line electrically connected to the gate driver. The gate driver can supply a pulse of a dummy gate signal to the dummy gate line. The selector can be connected to two data lines that are disposed in the non-display area of the display panel and spaced at a predetermined distance, and the dummy gate line.

According to aspects of the present disclosure, the data driver can include a first channel that outputs a first selection voltage having a voltage selected according to a refresh rate of the pixel areas and a data voltage corresponding to pixel data of an input image; and a second channel that outputs a second selection voltage having a voltage selected according to the refresh rate of the pixel areas and a data voltage corresponding to the pixel data of the input image. A first data line of the spaced two data lines can be connected to an output terminal of the first channel. A second data line of the spaced two data lines can be connected to an output terminal of the second channel.

According to aspects of the present disclosure, the selector can include a first transistor including a gate electrode connected to the dummy gate line, a first electrode connected to the first data line, and a second electrode connected to a first gate node; a second transistor including a gate electrode connected to the first gate node, a first electrode to which a gate on voltage of the selection signal is applied, and a second electrode connected to the selection line; a first capacitor connected to the first gate node; a third transistor including a gate electrode connected to the dummy gate line, a first electrode connected to the second data line, and a second electrode connected to a second gate node; a fourth transistor including a gate electrode connected to the second gate node, a first electrode to which a gate off voltage of the selection signal is applied, and a second electrode connected to the selection line; and a second capacitor connected to the second gate node.

According to aspects of the present disclosure, channel characteristics of the second transistor and the fourth transistor can be different.

According to aspects of the present disclosure, each of the first selection voltage and the second selection voltage can be output as a high voltage or a low voltage from the data driver. The high voltage and the low voltage can be selected within a voltage range between a maximum voltage and a minimum voltage of the data voltage.

A display device according to another embodiment of the present disclosure includes a display panel in which a plurality of data lines, a plurality of gate lines, a plurality of power lines, at least one selection line, and a plurality of pixels are disposed; a data driver electrically connected to the data lines; a gate driver configured to supply a plurality of gate signals to the gate lines; and a selector configured to supply a selection signal to the selection line. A display area of the display panel is divided into a plurality of pixel areas that are driven at different frequencies in a first direction according to a voltage of the selection signal, and is divided into a plurality of pixel areas that are driven at different frequencies in a second direction according to a voltage of at least one of the gate signals.

According to aspects of the present disclosure, each of the pixels can include a plurality of sub-pixels. Each of the sub-pixels can include a light-emitting element; a driving transistor configured to drive the light-emitting element; a capacitor connected to the driving element; and first-first and first-second switch transistors can be connected in series to the capacitor. The first-first switch transistor can be turned on in response to a selection signal. The first-second switch transistor can be turned on in response to at least one of the gate signals.

A method for driving a display device according to one embodiment of the present disclosure includes generating a selection signal of which a voltage is selected according to a refresh rate of pixel areas divided in a first direction; generating a gate signal of which a voltage is selected according to a refresh rate of pixel areas divided in a second direction intersecting the first direction; and controlling a driving frequency of the pixel areas divided in the first direction and the second direction by applying the selection signal and the gate signal to the respective pixels.

According to the embodiments of the present disclosure, it is possible to decrease the refresh rate to reduce power consumption without causing degradation of image quality of an input image.

According to the embodiments of the present disclosure, it is possible to freely control the variable refresh rate within the screen of the display panel by controlling a driving frequency of pixels to be different in two-axis directions on the display panel.

The effects of the present disclosure are not limited to the effects described above, and other effects not described will be understood by those skilled in the art from the following description and the appended claims.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, in which:

FIG. 1 is a block diagram showing a display device according to an embodiment of the present disclosure;

FIG. 2 is a diagram showing an example of a plurality of pixel areas that are different in driving frequency of pixels;

FIG. 3 is a circuit diagram showing a pixel circuit according to the embodiment of the present disclosure;

FIG. 4 is a waveform chart showing driving signals that are applied to the pixel circuit shown in FIG. 3 in refresh frame and skip frame periods;

FIG. 5 are circuit diagrams showing a pixel circuit according to another embodiment of the present disclosure;

FIG. 6 is a waveform chart showing driving signals that are applied to the pixel circuit shown in FIGS. 5 in refresh frame and skip frame periods;

FIG. 7 is a diagram schematically showing a selector according to the embodiment of the present disclosure;

FIG. 8 is a circuit diagram specifically showing an example of the selector shown in FIG. 7;

FIG. 9 is a diagram schematically showing a selector according to another embodiment of the present disclosure;

FIG. 10 is a circuit diagram specifically showing an example of the selector shown in FIG. 9;

FIG. 11 is a circuit diagram specifically showing another example that can be applied to the selectors shown in FIGS. 8 and 10;

FIG. 12 is a diagram showing an example of a selection voltage that is output from a data driver; and

FIGS. 13 and 14 are diagrams showing a device configuration in which pixel areas that are different in driving frequency of pixels are divided in a second direction of a display panel.

### DETAILED DESCRIPTION OF THE EMBODIMENTS

The advantages and features of the present disclosure and methods for accomplishing the same will be more clearly understood from embodiments described below with reference to the accompanying drawings. However, the present disclosure is not limited to the following embodiments but can be implemented in various different forms. Rather, the present embodiments will make the disclosure of the present disclosure complete and allow those skilled in the art to completely comprehend the scope of the present disclosure.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present specification. Further, in describing the present disclosure, detailed descriptions of known related technologies can be omitted to avoid unnecessarily obscuring the subject matter of the present disclosure.

The terms such as “comprising,” “including,” “having,” and “consist of” used herein are generally intended to allow other components to be added unless the terms are used with the term “only.” Any references to singular can include plural unless expressly stated otherwise.

Components are interpreted to include an ordinary error range even if not expressly stated.

When a positional or interconnected relationship is described between two components, using terms such as “on top of,” “above,” “below,” “next to,” “connect or couple with,” “crossing,” “intersecting,” or the like, one or more other components can be interposed between them, unless “immediately” or “directly” is used.

When a temporal antecedent relationship is described, using terms such as “after,” “following,” “next to,” “before,” or the like, it may not be continuous on a time base unless “immediately” or “directly” is used.

The terms such as “first,” “second,” and the like can be used to distinguish elements from each other, but the functions or structures of the components are not limited by ordinal numbers or component names in front of the components. Further, the term “may” fully encompasses all the meanings and coverages of the term “can” and vice versa.

The following embodiments of the present disclosure can be partially or entirely bonded to or combined with each other and can be linked and operated in technically various ways. The embodiments can be carried out independently of or in association with each other.

The pixel circuit and the gate drive circuit of the display device can include a plurality of transistors. The transistor can be implemented as a thin film transistor (TFT). The transistors can be implemented as an oxide thin film transistor (Oxide TFT) including an oxide semiconductor, a low temperature poly silicon TFT (LTPS TFT) including a low temperature poly silicon, and the like.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons can flow from a source to a drain. The n-channel transistor has a direction of a current flowing from the drain to the source. In the case of a p-channel transistor (p-channel metal-oxide semiconductor, since carriers are holes, a source voltage is higher than a drain voltage such that holes can flow from a source to a drain. In the p-channel transistor, since holes flow from the source to the drain, current flows from the source to the drain. It should be noted that a source and a drain of a transistor are not fixed. For example, a source and a drain can be changed according to an applied voltage. Therefore, the disclosure does not limit a source and a drain of a transistor. In the following description, a source and a drain of a transistor will be referred to as a first electrode and a second electrode.

A gate signal swings between a gate-on voltage and a gate-off voltage. A transistor is turned on in response to a gate-on voltage and is turned off in response to a gate-off voltage. In the case of an n-channel transistor, the gate-on voltage can be a gate high voltage VGH, and the gate-off voltage can be a gate low voltage VGL. In the case of a p-channel transistor, the gate-on voltage can be the gate low voltage VGL, and the gate-off voltage can be the gate high voltage VGH.

Hereinafter, various embodiments of the present disclosure will be described in detail with reference to the accompanying drawings. All the components of each display device/apparatus according to all embodiments of the present disclosure are operatively coupled and configured.

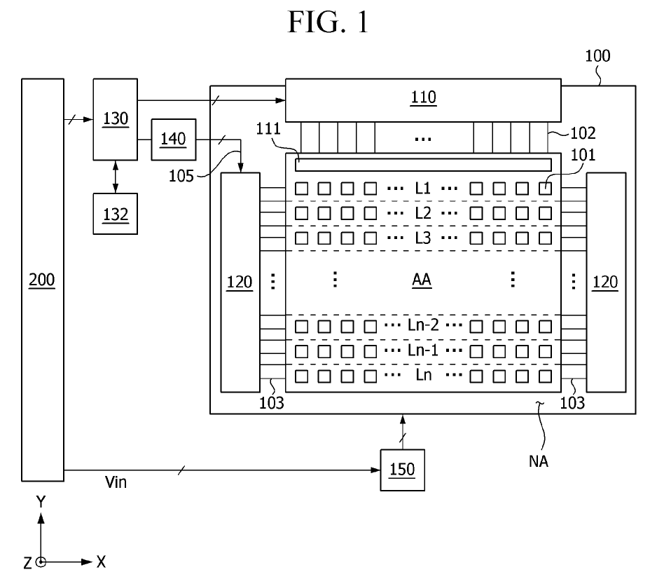

FIG. 1 is a diagram showing a display device according to an embodiment of the present disclosure.

Referring to FIG. 1, the display device according to the embodiment of the present disclosure includes a display panel 100, a display panel driving circuit for writing pixel data (or video data) to pixels 101 of the display panel 100, a power supply 150 that generates power necessary for driving the pixels 101 and the display panel driving circuit.

The display panel 100 can be a rectangular panel having a breadth (or width) in the X-axis direction, a length in the Y-axis direction, and a thickness in the Z-axis direction, but is not limited thereto. The X-axis direction, the Y-axis direction, and the Z-axis direction can be interpreted as a first direction, a second direction, and a third direction, respectively.

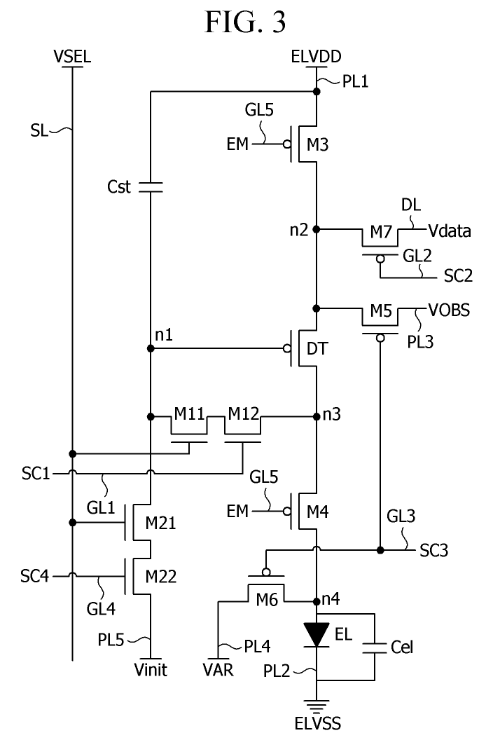

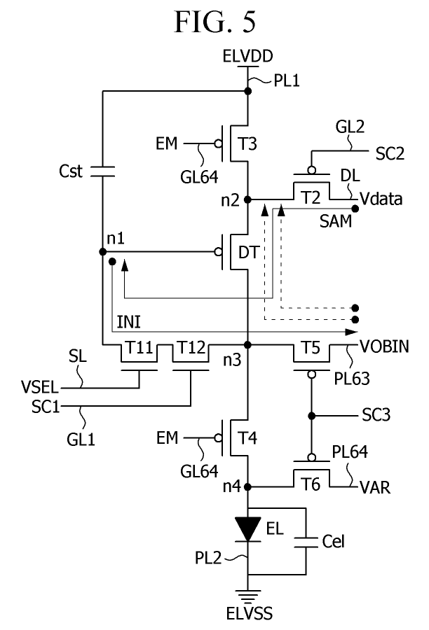

A screen of the display panel 100 can include a display area AA (or active area) and a non-display area NA (or non-active area) outside the display area AA. The display area AA of the display panel 100 includes a pixel array that displays an input image. The pixel array includes a plurality of data lines 102, a plurality of gate lines 103 intersecting the data lines 102, and pixels disposed in a matrix. The display panel 100 can further power lines connected in common to two or more pixels. The power lines can be connected in common to pixel circuits to supply power necessary for driving the pixels 101 to the pixels 101. The pixel array further includes one or more selection signal lines (in FIGS. 3 and 5, SL). The selection signal line SL supplies, to the pixels 101, a selection signal (in FIGS. 3 and 5, VSEL) for selecting a driving frequency of pixels according to a refresh rate of a pixel area in the first direction X.

The data lines 102 are disposed in the form of long wires along the Y-axis direction of the display panel 100 and are electrically connected to output terminals of a data driver 110. The gate lines 103 are disposed in the form of long wires along the X-axis direction of the display panel 100, intersect the data lines 102, and are electrically connected to output terminals of a gate driver 120.

Each of the pixels 101 can be divided into a red sub-pixel, a green sub-pixel, and a blue sub-pixel for color implementation. Each of the pixels can further include a white sub-pixel. Each of the sub-pixels includes a pixel circuit for driving a light-emitting element. Each pixel circuit is connected to the data line, the gate lines, and the power lines. The pixel circuit can be implemented as circuits shown in FIGS. 3 and 5, but is not limited thereto.

The pixel array includes a plurality of pixel lines L1 to Ln. Each of the pixel lines L1 to Ln includes one line of pixels disposed along the X-axis direction in the pixel array of the display panel 100. Pixels disposed in one pixel line share the gate lines 103. Sub-pixels disposed along the Y-axis direction in the data line direction share the same data line 102. One horizontal period 1 H can be a time obtained by dividing one frame period by the total number of pixel lines L1 to Ln.

The display panel 100 can be implemented as a non-transmissive display panel or a transmissive display panel. The transmissive display panel can be applied to a transparent display device in which an image is displayed on a screen and a real object in a background is visible. The display panel 100 can be manufactured as a flexible display panel.

The power supply 150 adjusts a level of a direct-current input voltage Vin applied from a host system 200 and outputs a voltage necessary for driving the pixel array of the display panel 100 and the display panel driving circuit. The power supply 150 can include a DC-DC converter. The DC-DC converter can include a charge pump, a regulator, a buck converter, a boost converter, and the like. The power supply 150 can output a gamma reference voltage, a gate high voltage, a gate low voltage, a pixel driving voltage, a pixel ground voltage, a pixel compensation voltage, an integrated circuit (IC) driving voltage, and the like through the DC-DC converter. The voltages that are output from the power supply 150 can be constant voltages (or direct-current voltages), but are limited thereto. The gamma reference voltage is supplied to the data driver 110. A dynamic range of a data voltage that is output from the data driver 110 is determined according to a voltage range of the gamma reference voltage. The dynamic range of the data voltage has a voltage range between a highest grayscale voltage and a lowest grayscale voltage. The gate high voltage and the gate low voltage are supplied to a level shifter 140 and the gate driver 120. The voltages such as the pixel driving voltage, the pixel ground voltage, and the pixel compensation voltage are supplied to the pixels 101. The IC driving voltage is a driving voltage of a drive IC in which circuits such as a timing controller 130 and the data driver 110 are embedded. The power supply 150 can be implemented as a power IC such as a power management integrated circuit (PMIC) or an electronics integrated circuit (ELIC). The output voltages of the power supply 150 can be varied under the control of the timing controller 130.

The display panel driving circuit writes pixel data of an input image to the pixels of the display panel 100 under the control of the timing controller 130. The display panel driving circuit includes the data driver 110 and the gate driver 120. The display panel driving circuit can further include demultiplexers (DEMUX) disposed between the data driver 110 and the data lines 102, but embodiments of the present disclosure are not limited thereto. When the demultiplexers are disposed between the output terminals of the data driver 110 and the data lines 102, the number of channels (or the number of output terminals) electrically connected to the data lines 102 can be reduced.

The display panel driving circuit further includes a selector 111 for controlling pixel areas that are different in driving frequency in the first direction X. The selector 111 can be disposed in the non-display area NA of the display panel 100, but embodiments of the present disclosure are not limited thereto. For example, the selector 111 can be implemented as one drive IC along with the data driver 110. The selector 111 can output a selection signal VSEL in response to a voltage output from the data driver 110 and a dummy gate signal. The selection signal VSEL is applied to sub-pixels via the selection signal line formed on the display panel 100 and selects pixel areas that are different in driving frequency in the first direction X.

Touch sensors for sensing a touch input can be disposed on the display panel 100. The touch sensors can be disposed on the display panel 100 as an on-cell type or an add on type or can be implemented as in-cell type touch sensors that are embedded in the pixel array.

The display panel driving circuit can further include a touch sensor driver for driving the touch sensors. The touch sensor driver is omitted in FIG. 1. The data driver 110 and the touch sensor driver can be integrated in one drive IC.

The data driver 110 is electrically connected to the data lines 102 and supplies a data voltage corresponding to the pixel data of the input image to the data lines 102. Each of channels of the data driver 110 can convert the pixel data of the input image received as a digital signal from the timing controller 130 into a gamma compensation voltage using a digital-to-analog converter (hereinafter, referred to as "DAC") and can output a data voltage corresponding to a grayscale value of the pixel data. The data driver 110 can divide the gamma reference voltage input from the power supply 150 into gamma compensation voltages having different voltage levels by grayscale using a voltage distribution circuit (or a voltage division circuit). The gamma compensation voltage is supplied to the DAC of the data driver 110. The data voltage can be output from each of the channels of the data driver 110 via an output buffer and can be applied to the data lines 102.

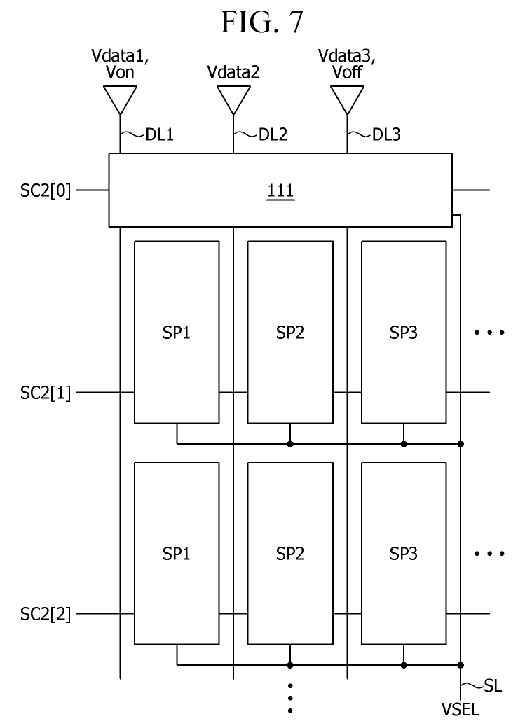

When selection data is received as a digital signal from the timing controller 130, the data driver 110 converts the selection data into the selection signal VSEL using the DAC and outputs the selection signal VSEL. The DAC can convert the selection data into a gamma compensation voltage and can output first and second selection voltages Von and Voff shown in FIGS. 7-10. The DAC can convert the pixel data of the input image into a gamma compensation voltage and can output data voltages DATA1 to DATA(n) shown in FIGS. 7- 10.

The gate driver 120 can be disposed in the non-display area NA on at least one of the right and left sides outside the display area AA in the display panel 100 or at least a part thereof can be disposed within the display area AA. The gate driver 120 can be disposed in the non-display areas NA on both sides of the display panel 100 with the display area AA of the display panel interposed therebetween, and can supply gate pulses from both sides of the gate lines 103 by a double feeding method. The gate driver 120 sequentially outputs the pulses of the gate signals to the gate lines 103 under the control of the timing controller 130. The gate driver 120 can shift the pulses of the gate signals using a shift register or an edge trigger to sequentially supply these signals to the gate lines 103. The gate driver 120 can include a plurality of gate drivers. Each of the plurality of gate drivers can be implemented as a shift register or an edge trigger.

The gate driver 120 can supply a dummy gate signal to a dummy gate line disposed in the non-display area NA outside the display area AA. The dummy gate signal can be provided to the selector 111.

The timing controller 130 receives digital video data of an input image and a timing signal synchronized with data from the host system 200. The timing signal can include a vertical synchronization signal Vsync, a horizontal synchronization signal Hsync, a data enable signal DE, and the like. Because a vertical period and a horizontal period can be known by a method of counting the data enable signal DE, the vertical synchronization signal Vsync and the horizontal synchronization signal Hsync can be omitted. The horizontal synchronization signal Hsync and the data enable signal DE have a cycle of one horizontal period 1 H. A data voltage of pixel data can be simultaneously charged in the sub-pixels disposed in one pixel line in one horizontal period 1 H, and the pixel data can be written to the sub-pixels.

The timing controller 130 generates a data timing control signal for controlling an operation timing of the data driver 110 and a gate timing control signal for controlling an operation timing of the gate driver 120 on the basis of the timing signal (Vsync, Hsync, DE) received from the host system 200. The timing controller 130 controls the operation timing of the display panel driving circuit to synchronize the data driver 110 and the gate driver 120. The timing controller 130 can be implemented as an application-specific integrated circuit (ASIC).

The level shifter 140 can generate a start signal, a clock signal, a masking signal, and the like from the gate timing control signal received from the timing controller 130, convert voltages of these signals to have a swing width between a gate high voltage and a gate low voltage, and provide the converted signals to the gate driver 120 via clock wires 105. The gate driver 120 can output the pulses of the gate signals in response to the start signal and the clock signal input from the level shifter 140.

The display panel driving circuit can drive the pixels 101 at a variable refresh rate under the control of the timing controller 130. The timing controller 130 can decrease a refresh rate of an image that is displayed on the display panel 100, according to a frequency of an input image or on the basis of a result of analyzing the input image, thereby reducing the power consumption of the display device and improving image quality. With the variable refresh rate, a refresh driving frequency of the pixels can vary to 1 Hz, 30 Hz, 60 Hz, 120 Hz, 144 Hz, 165 Hz, 240 Hz, and the like, but embodiments of the present disclosure are not limited thereto.

The pixels are charged with the data voltage of the pixel data in conformity with frames per second (FPS) that is varied in real time according to the variable refresh rate. The unit of the variable refresh rate is Hertz (Hz). When the refresh rate is 60 Hz, the pixel data is written to the pixels for each frame period of 60 frames per second, and when the refresh rate is increased to 120 Hz, the pixel data is written to the pixels for each frame period of 120 frames per second. In a display device in which the variable refresh rate is supported, the refresh driving frequency of the pixels at which the pixel data is written to the pixels varies according to the variable refresh rate. The refresh driving frequency is a driving frequency of the pixels generated when the pixel data is written by the frames per second (FPS) that changes in conformity with the variable refresh rate.

A skip driving frequency is a driving frequency of the pixels at which new pixel data is not written and the data voltage of the pixel data charged in a previous refresh frame is maintained. When the pixels are skip-driven, initialization and a data writing step are not performed. For this reason, during skip driving, power consumption in the display panel 100 and the display panel driving circuit is significantly small compared to during refresh driving.

The variable refresh rate does not maintain and varies in real time a frame refresh rate per second of an image that is reproduced on a screen of the display panel 100. In displaying an image of content such as a game or animation on the display panel 100, the display panel driving circuit can adjust the refresh driving frequency of the pixels 101 in conformity with the frames per second (FPS) of the image under the control of the timing controller 130, thereby reducing a problem such as tearing or stuttering of the image that is reproduced on the screen of the display panel 100.

The timing controller 130 can determine the refresh rate of the input image in real time by counting the input timing signal (Vsync, Hsync, DE) with the clock. The vertical synchronization signal Vsync defines one frame period. One pulse cycle of the horizontal synchronization signal Hsync and the data enable signal DE is one horizontal period 1 H. The data enable signal DE defines a valid data interval in which the pixel data of the input image is present.

The display panel driving circuit can decrease the refresh rate of the pixels 101 when a still image is input for a given time under the control of the timing controller 130, thereby reducing the power consumption of the display device, and can increase the refresh driving frequency of the pixels according to the refresh rate of the input image, thereby implementing image quality to image quality optimized for the content of the input image. The refresh rate can be decreased when the display device operates in a standby mode or in response to a user's command. Further, the refresh rate can be decreased on an always on display (AOD) screen. The AOD screen can be a partial pixel area of the display area AA where preset information, for example, brief information such as a remaining amount of battery power and time is displayed in the standby mode.

The host system 200 can convert the resolution of an image signal from a video source to match the resolution of the display panel 100 and can transmit the image signal to the timing controller 130 along with the timing signal.

A memory 132 can store driving setting timing information of the display panel driving circuit, a program code of a compensation algorithm for improving image quality, and the like. The memory 132 can include a non-volatile memory and a volatile memory. The non-volatile memory can include one or more of readable and writable memories, for example, a NAND flash memory, a NOR flash memory, and an electrically erasable programmable read-only memory (EEPROM). The NAND flash memory can be a single level cell (SLC) type. The volatile memory can include one or more of a dynamic RAM (DRAM), a static RAM (SRAM), a synchronous dynamic RAM (SDRAM), and a double data rate SDRAM (DDR SDRAM).

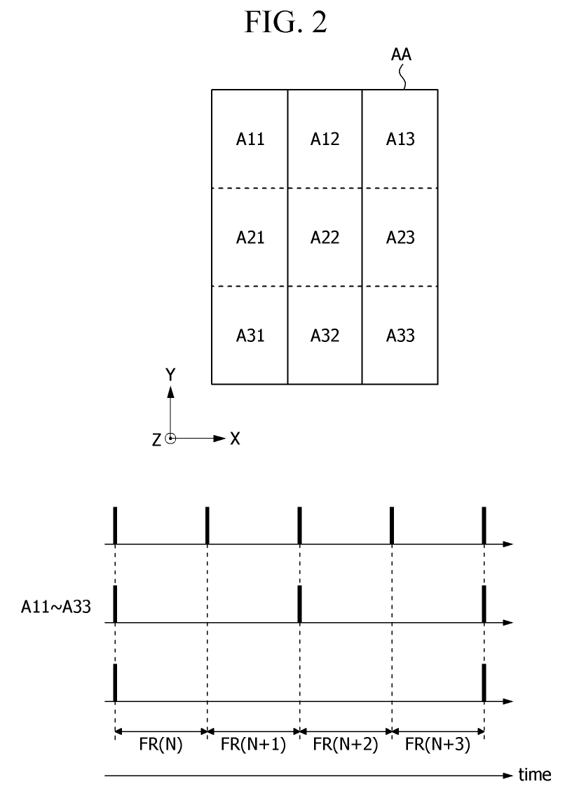

The display panel driving circuit can control the pixels spatially divided within one screen at different driving frequencies and can temporally vary the driving frequency of the pixels at a variable refresh rate under the control of the timing controller 130 as shown in FIG. 2.

FIG. 2 is a diagram showing an example of a plurality of pixel areas that are different in driving frequency of the pixels. In FIG. 2, "FR(N) to FR(N+3)" indicate N-th (where N is a natural number) to (N+3)th frame periods. It should be noted that pixel areas A11 to A33 and refresh rates shown in FIG. 2 are merely illustrative, and pixels areas and refresh rates are not limited to those shown in FIG. 2. In FIG. 2, a thick line indicates a sampling period during which data is written at a refresh frame.

Referring to FIG. 2, the display area AA can be divided into two or more pixel areas A11 to A33 in at least one direction of a first direction X and a second direction Y in terms of the driving frequency of the pixels. Each of the pixel areas A11 to A33 includes one or more pixels.

The timing controller 130 can control the data driver 110 and the gate driver 120 to independently control the driving frequency of the pixels by divided pixel area within the screen. The timing controller 130 can increase a driving frequency of a pixel area where data update at a high refresh rate is required, and can decrease a driving frequency of a pixel area where degradation of image quality is not visible even when data is updated at a low refresh rate. The driving frequency of the pixels is proportional to the refresh rate. The pixels of the pixel areas A11 to A33 can be driven at a variable refresh rate of 30 Hz, 60 Hz, 120 Hz, and the like, and the pixels can be driven at a frequency of a different refresh rate by pixel area within one frame period.

In the example of FIG. 2, A11, A12, and A13 are pixel areas that are divided in the first direction X and can be driven such that the driving frequency of the pixels is different. A position and a size of each of the pixel areas divided in the first direction X can be controlled by a selection signal (in FIGS. 3 and 5, VSEL) described below. A11, A21, and A31 are pixel areas that are divided in the second direction Y and can be driven such that the driving frequency of the pixels is different. A position and a size of each of the pixel areas divided in the second direction Y can be controlled by gate signals, for example, SC1 and SC4 in FIG. 3 that control transistors connected to a capacitor (in FIGS. 3 and 5, Cst). The timing controller 130 can control the driving frequency of the pixels according to the refresh rate of each of the pixel areas A11 to A33 by controlling the on and off of the transistors connected to the capacitor Cst in each of the sub-pixels as shown in FIGS. 3-6.

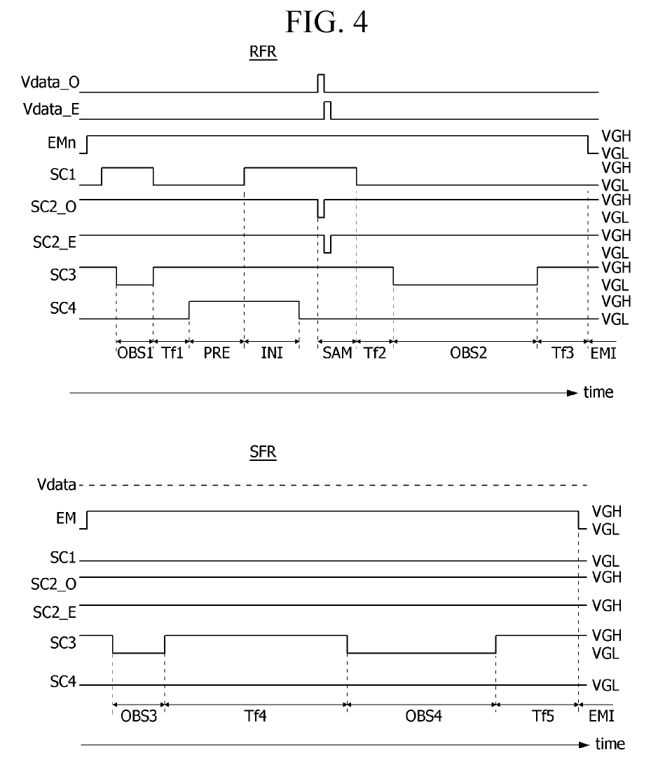

FIG. 3 is a circuit diagram showing a pixel circuit according to the embodiment of the present disclosure. FIG. 4 is a waveform chart showing driving signals that are applied to the pixel circuit shown in FIG. 3 in refresh frame and skip frame periods. In FIG. 4, a second scan signal SC2_O is a gate signal that is applied to sub-pixels of an odd-numbered pixel line in synchronization with an odd-numbered data voltage Vdata_O. A second scan signal SC2_E is a gate signal that is applied to sub-pixels of an even-numbered pixel line in synchronization with an even-numbered data voltage Vdata_E.

Referring to FIGS. 3 and 4, the pixel circuit includes a light-emitting element EL, a driving element DT that drives the light-emitting element EL, a plurality of switch elements M11 to M7, and a capacitor Cst. Each of a first-first switch element M11, a first-second switch element M12, a second-first switch element M21, and a second-second switch element M22 can be implemented as an n-channel oxide TFT, but embodiments of the present disclosure are not limited thereto. Each of the driving element DT, a third switch element M3, fourth switch element M4, a fifth switch element M5, a sixth switch element M6, and a seventh switch element M7 can be implemented as a p-channel LTPS TFT, but embodiments of the present disclosure are not limited thereto. For example, each of the first-first switch element M11, the first-second switch element M12, the second-first switch element M21, and the second-second switch element M22 can be turned on in response to a gate high voltage VGH of a corresponding gate signal in FIG. 4 and can be turned off in response to a gate low voltage VGL. Each of the third switch element M3, the fourth switch element M4, the fifth switch element M5, the sixth switch element M6, and the seventh switch element M7 can be turned on in response to the gate low voltage VGL of a corresponding gate signal in FIG. 4 and can be turned off in response to the gate high voltage VGH.

The pixel circuit is connected to a data line DL to which a data voltage Vdata of pixel data is applied, and gate lines GL1, GL2, GL3, GL4, and GL5 to which gate signals SC1, SC2, SC3, SC4, and EM are applied. The data voltage Vdata is applied to the data line DL in a sampling period SAM of a refresh frame period RFR. A third compensation voltage can be applied to the data line DL in a skip frame period SFR.

A pixel driving voltage ELVDD and a pixel ground voltage ELVSS are set to voltages at which the driving element DT can operate in a saturation region. The pixel driving voltage ELVDD can be set to a voltage of 2 V to 3 V and the pixel ground voltage ELVSS can be set to a voltage of -8 V to -10 V, but embodiments of the present disclosure are not limited thereto. The gate high voltage VGH can be set to a voltage higher than the pixel driving voltage ELVDD and the gate low voltage VGL can be set to a voltage lower than the pixel ground voltage ELVSS, but embodiments of the present disclosure are not limited thereto.

The data voltage Vdata can have a dynamic range of 2 V to 6 V. Within this dynamic range, a voltage level of the data voltage Vdata is selected according to a grayscale value of pixel data. An initialization voltage Vinit can be set to a voltage lower than a lower limit voltage of the data voltage Vdata and higher than the pixel ground voltage ELVSS. For example, when the lower limit voltage of the data voltage Vdata is 2 V, and the pixel ground voltage ELVSS is -9 V, the initialization voltage Vinit can be set to a voltage of -5 V to -7 V.

When the pixels 101 are driven at the variable refresh rate, a pixel compensation voltage can be applied to the pixel circuit to reduce a luminance difference between the refresh frame period RFR and the skip frame period SFR. The pixel compensation voltage can include a first compensation voltage VOBS, a second compensation voltage VAR, and the third compensation voltage.

The first compensation voltage VOBS is an on bias stress voltage (hereinafter, abbreviated as an "on bias voltage") that is applied to the driving element DT to reduce a difference in hysteresis characteristic between on and off states of the driving element DT. The first compensation voltage VOBS can be set to a voltage selected within a voltage range lower than the pixel driving voltage ELVDD and partially overlapping the dynamic range of the data voltage Vdata. For example, when the dynamic range of the data voltage Vdata is 2 V to 6 V, the first compensation voltage VOBS can be set to a voltage of 4 V to 8 V under the control of the timing controller 130.

The second compensation voltage VAR initializes an anode voltage and parasitic capacitance Cel of the light-emitting element EL. A low grayscale luminance level of the pixels 101 at a low grayscale can be optimized by appropriately adjusting an initialization voltage to be charged in the parasitic capacitance Cel of the light-emitting element EL according to the second compensation voltage VAR. For example, when the dynamic range of the data voltage Vdata is 2 V to 6 V, the second compensation voltage VAR can be set to a voltage of -4 V to -5 V.

The third compensation voltage can be set to a voltage for compensating for change in luminance of the pixels 101 between the refresh frame period and the skip frame period and can be applied to the data line DL in the skip frame period. The third compensation voltage can be set within a voltage range smaller than the dynamic range of the data voltage Vdata. For example, when the dynamic range of the data voltage Vdata is 2 V to 6 V, the third compensation voltage can be set to a certain voltage of 4 V to 6 V, but embodiments of the present disclosure are not limited thereto. The third compensation voltage can be output from the power supply 150 and can be applied to the data line DL via a separate switch element disposed on the display panel 100 or a switch element of the data driver 110.

The gate signals SC1, SC2, SC3, SC4, and EM include pulses that swing between the gate high voltage VGH and the gate low voltage VGL.

The timing controller 130 can control the driving frequency of the pixels during a refresh driving or skip driving by controlling the switch elements M11, M12, M21, and M22 connected to the capacitor Cst of the pixel circuit in each of the pixel areas A11 to A33.

The driving element DT includes a gate electrode connected to a first node n1, a first electrode connected to a second node n2, and a second electrode connected to a third node n3. The capacitor Cst is connected between a first power line PL1 to which the pixel driving voltage ELVDD is applied and the first node n1. The light-emitting element EL includes an anode electrode connected to a fourth node n4 and a cathode electrode connected to a second power line PL2 to which the pixel ground voltage ELVSS is applied. The light-emitting element EL can be implemented as an OLED, but embodiments of the present disclosure are not limited thereto. The OLED includes parasitic capacitance Cel due to a stacked structure.

The first-first switch element M11 and the first-second switch element M12 are connected in series between the first node n1 and the third node n3. A connection structure of the first-first switch element M11 and the first-second switch element M12 is not limited to that in FIG. 3. For example, the positions of the first-first switch element M11 and the first-second switch element M12 can be changed opposite to each other. The positions of the first-first switch element M11 and the first-second switch element M12 can be revered. When both the first-first switch element M11 and the first-second switch element M12 are turned on, the first node n1 is electrically connected to the third node n3. On the other hand, when at least one of the first-first switch element M11 and the first-second switch element M12 is turned off, the first node n1 is electrically separated from the third node n3.

The first-first switch element M11 is connected between the first node n1 and the first-second switch element M12, and is turned on in response to a gate high voltage VGH of the selection signal VSEL. When the first-first switch element M11 is turned on, the first-second switch element M12 can be electrically connected to the first node n1. The first-second switch element M12 is connected between the first-first switch element M11 and the third node n3, and is turned on in response to a gate high voltage VGH of a first scan signal SC1. When the first-second switch element M12 is turned on, the first-first switch element M11 can be electrically connected to the third node n3. The first-first switch element M11 includes a gate electrode connected to the selection signal line SL to which the selection signal VSEL is applied, a first electrode connected to the first node n1, and a second electrode connected to a first electrode of the first-second switch element M12. The first-second switch element M12 includes a gate electrode connected to a first gate line GL1 to which the first scan signal SC1 is applied, the first electrode connected to the second electrode of the first-first switch element M11, and a second electrode connected to the third node n3.

The second-first switch element M21 and the second-second switch element M22 are connected in series between the first node n1 and a fifth power line PL5 to which the initialization voltage Vinit is applied. A connection structure of the second-first switch element M21 and the second-second switch element M22 is not limited to that in FIG. 3. For example, the positions of the second-first switch element M21 and the second-second switch element M22 can be changed opposite to each other. The positions of the second-first switch element M21 and the second-second switch element M22 can be reversed. When both the second-first switch element M21 and the second-second switch element M22 are turned on, the initialization voltage Vinit can be applied to the first node n1. On the other hand, when at least one of the second-first switch element M21 and the second-second switch element M22 is turned off, the first node n1 is electrically separated from the fifth power line PL5 and is not initialized.

The second-first switch element M21 is connected between the first node n1 and the second-second switch element M22, and is turned on in response to the gate high voltage VGH of the selection signal VSEL. When the second-first switch element M21 is turned on, the first node n1 can be electrically connected to the second-second switch element M22. The second-second switch element M22 is connected between the second-first switch element M21 and the fifth power line PL5, and is turned in response to a gate high voltage VGH of a fourth scan signal SC4. When the second-second switch element M22 is turned on, the second-second switch element M22 can be electrically connected to the fifth power line PL5 to which the initialization voltage Vinit is applied. The second-first switch element M21 includes a gate electrode connected to the selection signal line SL to which the selection signal VSEL is applied, a first electrode connected to the first node n1, and a second electrode connected to a first electrode of the second-second switch element M22. The second-second switch element M22 includes a gate electrode connected to a fourth gate line GL4 to which the fourth scan signal SC4 is applied, the first electrode connected to the second electrode of the second-first switch element M21, and a second electrode connected to the fifth power line PL5.

The third switch element M3 is connected between the first power line PL1 and the second node n2, and is turned on in response to a gate low voltage VGL of an EM signal EM. When the third switch element M3 is turned on, the pixel driving voltage ELVDD is applied to the second node n2. The fourth switch element M4 is connected between the third node n3 and the fourth node n4, and is turned on in response to a gate low voltage VGL of the EM signal EM. When the fourth switch element M4 is turned on, the third node n3 is electrically connected to the fourth node n4. The third switch element M3 includes a gate electrode connected to a fifth gate line GL5 to which the EM signal EM is applied, a first electrode connected to the first power line PL1, and a second electrode connected to the second node n2. The fourth switch element M4 includes a gate electrode connected to the fifth gate line GL5, a first electrode connected to the third node n3, and a second electrode connected to the fourth node n4. The EM signal can be interpreted as an emission control signal or a fifth gate signal.

The fifth switch element M5 is connected between the second node n2 and a third power line PL3 to which the first compensation voltage VOBS is applied, and is turned on in response to a gate low voltage VGL of a third scan signal SC3. When the fifth switch element M5 is turned on, the first compensation voltage VOBS can be applied to the second node n2. The sixth switch element M6 is connected between the fourth node n4 and a fourth power line PL4 to which the second compensation voltage VAR is applied, and is turned on in response to the gate low voltage VGL of the third scan signal SC3. When the sixth switch element M6 is turned on, the second compensation voltage VAR can be applied to the anode electrode of the light-emitting element EL connected to the fourth node n4. The fifth switch element M5 includes a gate electrode connected to a third gate line GL3 to which the third scan signal SC3 is applied, a first electrode connected to the second node, and a second electrode connected to the third power line PL3. The sixth switch element M6 includes a gate electrode connected to the third gate line GL3, a first electrode connected to the fourth power line PL4, and a second electrode connected to the fourth node n4.

The seventh switch element M7 is connected between the data line DL and the second node n2, and is turned on in response to a gate low voltage VGL of a second scan signal SC2. When the seventh switch element M7 is turned on, the data line DL is electrically connected to the second node n2. The seventh switch element M7 includes a gate electrode connected to a second gate line GL2 to which second scan signal SC2 is applied, a first electrode connected to the second node n2, and a second electrode connected to the data line DL.

Refresh driving and skip driving of the pixel circuit will be described assuming that the first-first switch element M11 and the second-first switch element M21 are in an on state.

The pixel circuit can receive refresh driving signals shown in an upper diagram of FIG. 4 in the refresh frame period RFR, can be charged with the data voltage of the pixel data, and can be driven at the refresh driving frequency. The refresh frame period RFR can be divided into a first on bias period OBS1, a first initialization period PRE, a second initialization period INI, a sampling period SAM, a second on bias period OBS2, and an emission period EMI. In the refresh frame period RFR, the light-emitting element EL is in the off state and does not emit light in the first on bias period OBS1, the first initialization period PRE, the second initialization period INI, the sampling period SAM, and the second on bias period OBS2. The light-emitting element EL can be driven with a current from the driving element DT and emit light in the emission period EMI of the refresh frame period RFR.

A first floating period Tf1 can be set between the first on bias period OBS1 and the first initialization period PRE. A second floating period Tf2 can be set between the sampling period SAM and the second on bias period OBS2. A third floating period Tf3 can be set between the second on bias period OBS2 and the emission period EMI. In the floating periods Tf1, Tf2, and Tf3, because all the first to seventh switch elements M1 to M7 are in off states, the first to fourth nodes n1, n2, n3, and n4 are floated and maintained in previous states.

In the first on bias period OBS1, the fifth and sixth switch elements M5 and M6 are turned on, the first compensation voltage VOBS is applied to the second node n2, and the second compensation voltage VAR is applied to the fourth node n4. In the first on bias period OBS1, the first-first and first-second switch elements M11 and M12 are turned on, and the first node n1 is electrically connected to the third node n3.

In the first initialization period PRE, the second-first and second-second switch elements M21 and M22 are turned on, the initialization voltage Vinit is applied to the first node n1. In the second initialization period INI, the first-first switch element M11, the first-second switch element M12, the second-first switch element M21, and the second-second switch element M22 are turned on, the initialization voltage Vinit is applied to the first and third nodes n1 and n3, and the initialization voltage Vinit is also applied to the second node n2 via the driving element DT.

In the sampling period SAM, the seventh switch element M7 is turned on in response to the gate low voltage VGL of the second scan signal SC2. In this case, the data voltage Vdata of the pixel data is applied to the second node n2, and the data voltage Vdata is also applied to the first and third nodes n1 and n3 via the driving element DT in the on state. In the second on bias period OBS2, the fifth and sixth switch elements M5 and M6 are turned on, the first compensation voltage VOBS is applied to the second node n2, and the second compensation voltage VAR is applied to the fourth node n4.

In the emission period EMI of the refresh frame period RFR, the third and fourth switch elements M3 and M4 are turned on in response to the gate low voltage VGL of the EM signal EM. In the emission period EMI, a current path can be formed between the pixel driving voltage ELVDD and the light-emitting element EL via the third and fourth switch elements M3 and M4 and the light-emitting element EL can emit light with luminance corresponding to the grayscale value of the pixel data.

The pixel circuit can receive skip driving signals shown in a lower diagram of FIG. 4 in the skip frame period SFR and can be driven at the skip driving frequency lower than the refresh driving frequency. The skip frame period SFR can be divided into a third on bias period OBS3, a fourth on bias period OBS4, and an emission period EMI. A floating period can be present between the third on bias period OBS3 and the fourth on bias period OBS4. A floating period can be present between the fourth on bias period OBS4 and the emission period EMI. In the skip frame period SFR, the light-emitting element EL is in the off state and does not emit light in the third and fourth on bias periods OBS3 and OBS4. The light-emitting element EL can be driven with a current from the driving element DT in the emission period EMI of the skip frame period SFR.

The data driver 110 does not output the data voltage Vdata in the skip frame period SFR. In the skip frame period SFR, the third compensation voltage can be applied to the data line DL, but embodiments of the present disclosure are not limited thereto. In the skip frame period SFR, the voltages of the first and fourth scan signals SC1 and SC4 are maintained at the gate low voltage VGL, and the voltages of the second scan signals SC2_O and SC2_E are maintained at the gate high voltage VGH. In the skip frame period SFR, the first-first switch element M11, the first-second switch element M12, the second-first switch element M21, the second-second switch element M22, and the seventh switch element M7 are maintained in the off state. The gate driver 120 may not output other scan signals SC1, SC2_O, SC2_E, SC4 excluding the third scan signal SC3 in the skip frame period SFR. In the skip frame period SFR, the pixel circuit can be driven with the voltage of the capacitor Cst charged with the data voltage Vdata in a previous refresh frame period RFR and can cause the light-emitting element EL to emit light.

In the third and fourth on bias periods OBS3 and OBS4, the fifth and sixth switch elements M5 and M6 are turned on, the first compensation voltage VOBS is applied to the second node n2, and the second compensation voltage VAR is applied to the fourth node n4.

In the emission period EMI of the skip frame period SFR, the third and fourth switch elements M3 and M4 are turned on in response to the gate low voltage VGL of the EM signal EM. In the emission period EMI, a current path can be formed between the pixel driving voltage ELVDD and the light-emitting element EL via the third and fourth switch elements M3 and M4 and the light-emitting element EL can emit light with luminance corresponding to the grayscale value of the pixel data.

In the skip frame period SFR, the pixels can emit light with luminance corresponding to the grayscale of previously written pixel data. In the skip frame period, the power consumption of the data driver 110 and the gate driver 120 is considerably reduced. The skip driving frequency of the pixels 101 is significantly lower than the refresh driving frequency. Accordingly, when the pixels 101 are driven at the variable refresh rate, the power consumption of the display device can be reduced in a period during which an input image is normally reproduced on the display panel 100, and the consumption of a voltage charged in a battery connected to the host system 200 can be reduced.

On the other hand, when the first-first switch element M11 and the second-first switch element M21 are turned off, because the capacitor Cst in the pixel circuit is not initialized, the pixel circuit is skip-driven. Even when the refresh driving signals shown in the upper diagram of FIG. 4 are input to the pixel circuit, when the first-first switch element M11 and the second-first switch element M21 are turned off, the pixel circuit can be skip-driven.

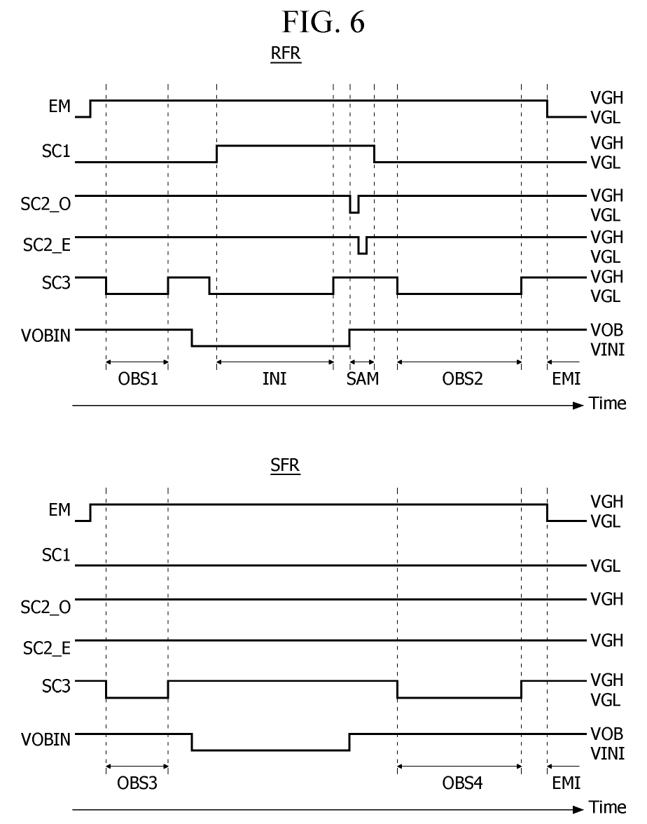

FIG. 5 are circuit diagrams showing a pixel circuit according to another embodiment of the present disclosure. FIG. 6 is a waveform chart showing driving signals that are applied to the pixel circuit shown in FIG. 5 in refresh frame and skip frame periods. In this embodiment, redundant description to the above-described embodiment will not be repeated.

Referring to FIGS. 5,and 6, the pixel circuit includes a light-emitting element EL, a driving element DT that drives the light-emitting element EL, a plurality of switch elements T11 to T6, and a capacitor Cst. The pixel circuit is connected to a data line DL, gate lines GL1, GL2, GL63, and GL64, and power lines PL1, PL2, PL63, and PL64. Each of first-first switch element T11 and a first-second switch element T12 can be implemented as an n-channel oxide TFT, but embodiments of the present disclosure are not limited thereto. Each of the driving element DT, a second switch element T2, a third switch element T3, a fourth switch element T4, a fifth switch element T5, and a sixth switch element T6 can be implemented as a p-channel LTPS TFT, but embodiments of the present disclosure are not limited thereto.

The first-first switch element T11 and the first-second switch element T12 can be turned on in response to a gate high voltage VGH of a first scan signal SC1 and can be turned off in response to a gate low voltage VGL. Each of the second switch element T2, the third switch element T3, the fourth switch element T4, the fifth switch element T5, and the sixth switch element T6 can be turned on in response to a gate low voltage VGL of a corresponding gate signal (SC2, SC3, EM) and can be turned off in response to a gate high voltage VGH.

The first-first switch element T11 and the first-second switch element T12 are connected in series between a first node n1 and a third node n3. A connection structure of the first-first switch element T11 and the first-second switch element T12 is not limited to that in FIG. 5. For example, the positions of the first-first switch element T11 and the first-second switch element T12 can be changed opposite to each other. When both the first-first switch element T11 and the first-second switch element T12 are turned on, the first node n1 is electrically connected to the third node n3. On the other hand, when at least one of the first-first switch element T11 and the first-second switch element T12 is turned off, the first node n1 is electrically separated from the third node n3.

The first-first switch element T11 is connected between the first node n1 and the first-second switch element T12, and is turned on in response to a gate high voltage VGH of a selection signal VSEL. When the first-first switch element T11 is turned on, the first-second switch element T12 can be electrically connected to the first node n1. The first-second switch element T12 is connected between the first-first switch element T11 and the third node n3, and is turned on in response to the gate high voltage VGH of the first scan signal SC1 in an initialization period INI and a sampling period SAM of a refresh frame period RFR. When the first-second switch element T12 is turned on, the first-first switch element T11 can be electrically connected to the third node n3. The first-first switch element T11 includes a gate electrode to which the selection signal VSEL is applied, a first electrode connected to the first node n1, and a second electrode connected to a first electrode of the first-second switch element T12. The first-second switch element T12 includes a gate electrode to which the first scan signal SC1 is applied, the first electrode connected to the second electrode of the first-first switch element T11, and a second electrode connected to the third node n3.

The second switch element T2 is connected between the data line DL and a second node n2 and is turned on in response to a gate low voltage VGL of a second scan signal SC2 in the sampling period SAM of the refresh frame period RFR. When the second switch element T2 is turned on, the data line DL is electrically connected to the second node n2. The second switch element T2 includes a gate electrode to which the second scan signal SC2 is applied, a first electrode connected to the second node n2, and a second electrode connected to the data line DL.

The third switch element T3 is connected between a first power line PL1 and the second node n2, and is turned on in response to a gate low voltage VGL of an EM signal EM in an emission period EMI. When the third switch element T3 is turned on, a pixel driving voltage ELVDD can be applied to the second node n2. The fourth switch element T4 is connected between a third node n3 and a fourth node n4, and is turned on in response to the gate low voltage VGL of the EM signal EM in the emission period EMI. When the fourth switch element T4 is turned on, the third node n3 can be electrically connected to the fourth node n4. The third switch element T3 includes a gate electrode connected to a fourth gate line GL64 to which the EM signal EM is applied, a first electrode connected to the first power line PL1, and a second electrode connected to the second node n2. The fourth switch element T4 includes a gate electrode connected to the fourth gate line GL64, a first electrode connected to the third node n3, and a second electrode connected to the fourth node n4.

The fifth switch element T5 is connected between the third node n3 and a third power line PL63 to which a first compensation voltage VOBIN is applied, and is turned on in response to a gate low voltage VGL of a third scan signal SC3. The first compensation voltage VOBIN is an alternating-current voltage that swings between an on bias voltage VOB and an initialization voltage VINI as shown in FIG. 6. The on bias voltage VOB is a voltage higher than the initialization voltage VINI. The on bias voltage VOB is applied to the third node n3 via the fifth switch element T5 in on bias periods OBS1 to OBS4. The initialization voltage VINI is applied to the third node n3 via the fifth switch element T5 in the initialization period INI. The on bias voltage VOB corresponds to the first compensation voltage VOBS in the above-described embodiment, and the initialization voltage VINI corresponds to the initialization voltage Vinit in the above-described embodiment.

The sixth switch element T6 is connected between the fourth node n4 and a fourth power line PL64, and is turned on in response to the gate low voltage VGL of the third scan signal SC3. The second compensation voltage VAR is applied to the fourth node n4 via the sixth switch element T6 in the on bias periods OBS1 to OBS4.

On the other hand, when the first-first switch element T11 is turned off, because the capacitor Cst in the pixel circuit is not initialized, the pixel circuit is skip-driven. Even when refresh driving signals shown in an upper diagram of FIG. 6 are input to the pixel circuit, when the first-first switch element T11 is turned off, the pixel circuit can be skip-driven.

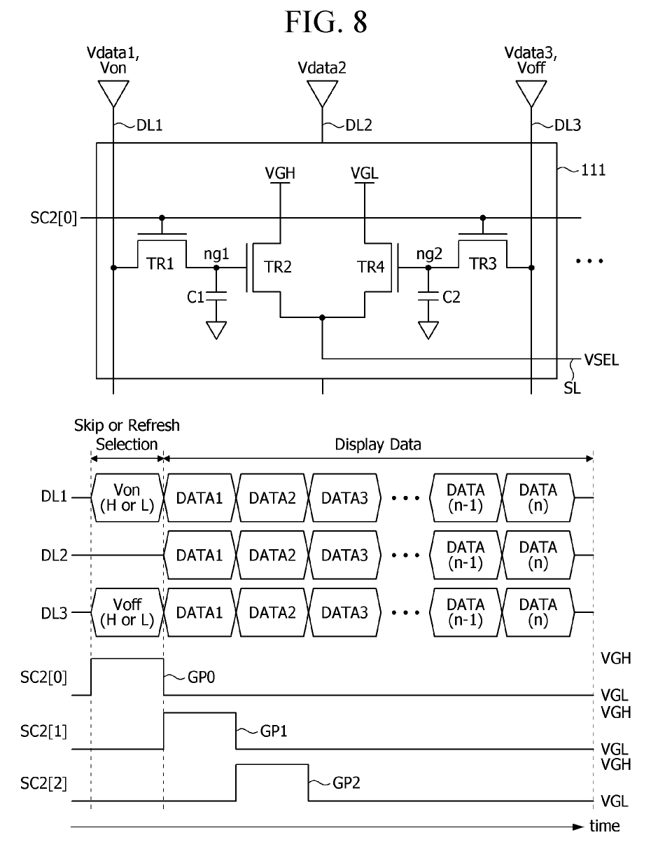

FIG. 7 is a diagram schematically showing a selector according to the embodiment of the present disclosure. In FIG. 7, SP1 to SP3 are sub-pixels. FIG. 8 is a circuit diagram showing an example of the selector shown in FIG. 7.

Referring to FIGS. 1, 7, and 8, a selector 111 can be disposed in an upper non-display area NA of the display panel 100. The selector 111 can be connected to data lines DL1 and DL3 spaced at a predetermined distance and a dummy gate line. The dummy gate line can be disposed in a non-display area NA outside an upper portion of the display area AA in the display panel 100. A dummy gate signal SC2[0] can be applied to the dummy gate line. The dummy gate signal SC2[0] can be output from the gate driver that outputs the second scan signal SC2, but embodiments of the present disclosure are not limited thereto. For example, the dummy gate signal that is output from the gate driver, which outputs other gate signals SC1, SC3, SC4, and EM, can be applied to the selector 111.

Referring to FIG. 8, the selector 111 can include first to fourth transistors TR1 to TR4 and first and second capacitors C1 and C2. The transistors TR1 to TR4 can be implemented as n-channel transistors, for example, n-channel oxide TFTs, but embodiments of the present disclosure are not limited thereto.

Each of the first and third transistors TR1 and TR3 can be turned on in response to a pulse GP0 of the dummy gate signal applied via the dummy gate line. When the first transistor TR1 is turned on, a first data line DL1 can be electrically connected to a first gate node ng1. The second transistor TR2 is turned on when a first selection voltage Von that is applied to the first gate node ng1 is a high voltage H and supplies a gate high voltage VGH to a selection line SL, and is turned off when the first selection voltage Von is a low voltage L. The first transistor TR1 includes a gate electrode connected to the dummy gate line, a first electrode connected to the first data line DL1, and a second electrode connected to the first gate node ng1. The second transistor TR2 includes a gate electrode connected to the first gate node ng1, a first electrode to which the gate high voltage VGH is applied, and a second electrode connected to the selection line SL. The gate high voltage VGH can be interpreted as the gate on voltage of the selection signal VSEL. The selection line SL can be arranged in the display area AA of the display panel 100 so as to be parallel to the data line DL and intersect the gate lines GL1 to GL5, as illustrated in FIG. 7. In the display area AA, a line branching from the selection line SL are connected to the sub-pixels SP1, SP2, and SP3.

When the third transistor TR3 is turned on, a third data line DL3 can be electrically connected to a second gate node ng2. The data line that is connected to the third transistor TR3 is not limited to the third data line DL3. For example, when a second selection voltage Voff is applied to a second data line DL2, the third transistor TR3 can be connected to the second data line DL2. The fourth transistor TR4 is turned on when the second selection voltage Voff that is applied to the second gate node ng2 is a high voltage H and supplies a gate low voltage VGL to the selection line SL, and is turned off when the second selection voltage Voff is a low voltage L. The third transistor TR3 includes a gate electrode connected to the dummy gate line, a first electrode connected to the third data line DL3, and a second electrode connected to the second gate node ng2. The fourth transistor TR4 includes a gate electrode connected to the second gate node ng2, a first electrode to which the gate low voltage VGL is applied, and a second electrode connected to the selection line SL. The gate low voltage VGL can be interpreted as the gate off voltage of the selection signal VSEL.

When the first selection voltage Von is the high voltage H, and the second selection voltage Voff is the low voltage L, the voltage of the selection signal VSEL is the gate high voltage VGH. When the second selection voltage Voff is the high voltage H, and the first selection voltage Von is the low voltage L, the voltage of the selection signal VSEL is the gate low voltage VGL. The pixels to which the selection signal VSEL is applied at the gate high voltage VGH can be refresh-driven when the refresh driving signals are applied. The pixels to which the selection signal VSEL is applied at the gate low voltage VGL can be skip-driven because the voltage of the capacitor Cst is maintained in a previous state even when the refresh driving signals are applied.

The first capacitor C1 can be charged with the first selection voltage Von applied to the first gate node ng1 and can maintain the gate voltage of the second transistor TR2 at the first selection voltage Von in one frame period. A first electrode of the first capacitor C1 can be connected to the first gate node ng1, and a second electrode of the first capacitor C1 can be connected to a power line to which a ground voltage or a reference voltage is applied. The second capacitor C2 can be charged with the second selection voltage Voff applied to the second gate node ng2 and can maintain the gate voltage of the fourth transistor TR4 at the second selection voltage Voff in one frame period. A first electrode of the second capacitor C2 can be connected to the second gate node ng2, and a second electrode of the second capacitor C2 can be connected to the power line to which the ground voltage or the reference voltage is applied. The capacitance of each of the first and second capacitors C1 and C2 can be substantially the same as the capacitance of the capacitor Cst of the pixel circuit.

A first channel of the data driver 110 can supply the first selection voltage Von corresponding to selection data received from the timing controller 130 and the data voltage DATA1 to DATA(n) corresponding to the pixel data of the input image to the first data line DL1. A second channel of the data driver 110 can supply the data voltage DATA1 to DATA(n) corresponding to the pixel data of the input image to the second data line DL2. A third channel of the data driver 110 can supply the second selection voltage Voff corresponding to selection data received from the timing controller 130 and the data voltage DATA1 to DATA(n) corresponding to the pixel data of the input image to the third data line DL3. The first and second selection voltages Von and Voff can be output in synchronization with the pulse GP0 of the dummy gate signal SC2[0] before the data voltage DATA1 to DATA(n) and can divide pixel areas that are different in driving frequency in the first direction of the display panel 100 in a current frame period. The gate driver 120 can sequentially output pulses GP1 and GP2 of gate signals SC2[1] and SC2[2] that are applied to the pixel lines of the display area AA, after outputting the pulse GP0 of the dummy gate signal SC2[0].

The timing controller 130 can determine a logical value of the selection data according to the refresh rate of each of the pixel areas divided in the first direction of the display panel 100. Accordingly, the timing controller 130 can control the voltage of each of the selection voltages Von and Voff that are output from the data driver 110, according to the refresh rate of each of the pixel areas.

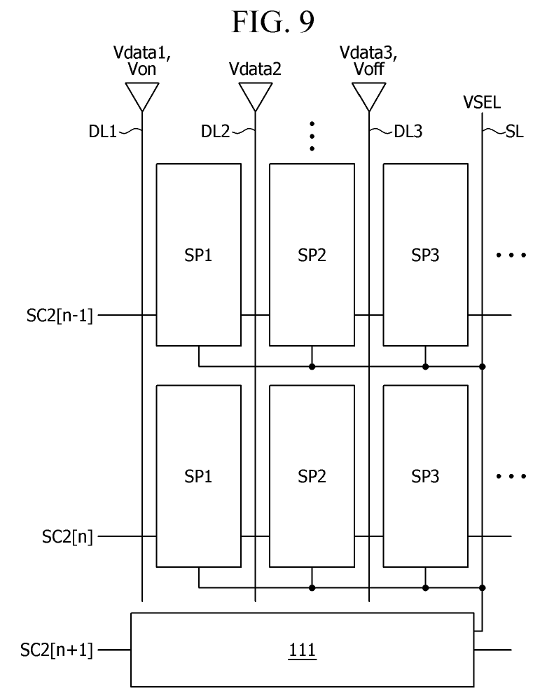

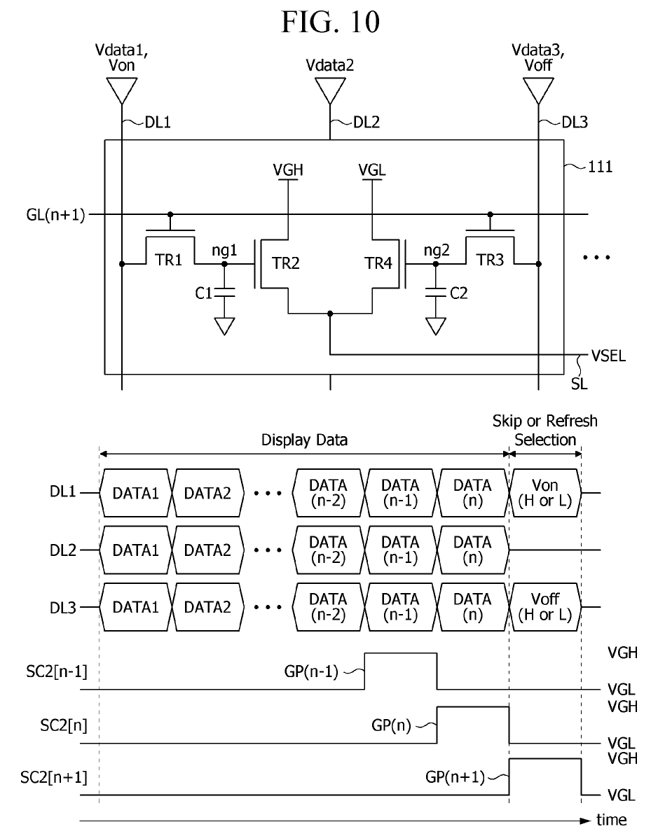

FIG. 9 is a diagram schematically showing a selector according to another embodiment of the present disclosure. FIG. 10 is a circuit diagram showing an example of the selector shown in FIG. 9. In this embodiment, redundant description to the embodiment shown in FIGS. 7 and 8 described above will not be repeated or may be briefly provided.

Referring to FIGS. 9 and 10, a selector 111 can be disposed in a lower non-display area NA of the display panel 100.

In the selector 111, each of the first and third transistors TR1 and TR3 can be turned on in response to a pulse GP(n+1) of the dummy gate signal applied via the dummy gate line. When the first transistor TR1 is turned on, the first data line DL1 can be electrically connected to the first gate node ng1. The second transistor TR2 is turned on when a first selection voltage Von that is applied to the first gate node ng1 is the high voltage H and supplies the gate high voltage VGH to the selection line SL, and is turned off when the first selection voltage Von is the low voltage L.

When the third transistor TR3 is turned on, the third data line DL3 can be electrically connected to the second gate node ng2. The fourth transistor TR4 is turned on when the second selection voltage Voff that is applied to the second gate node ng2 is the high voltage H and supplies the gate low voltage VGL to the selection line SL, and is turned off when the second selection voltage Voff is the low voltage L. The first capacitor C1 is changed with the first selection voltage Von applied to the first gate node ng1. The second capacitor C2 is charged with the second selection voltage Voff applied to the second gate node ng2. The first and second selection voltages Von and Voff can be output in synchronization with a pulse GP(n+1) of a dummy gate signal SC2[n+1] after the data voltage DATA1 to DATA(n) and can divide pixel areas that are different in driving frequency in the first direction of the display panel 100 in a next frame period. The gate driver 120 can output the pulse GP(n+1) of the dummy gate signal SC2[n+1] after sequentially outputting pulses GP(n-1) and GP(n) of gate signals SC2[n-1] and SC2[n] that are applied to the pixel lines of the display area AA.

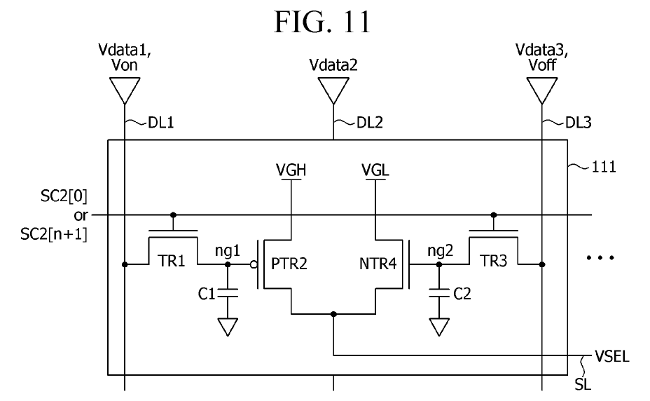

FIG. 11 is a circuit diagram specifically showing another example that can be applied to the selectors shown in FIGS. 8 and 10. In this embodiment, redundant description to the above-described embodiments will not be repeated or may be briefly provided.

Referring to FIG. 11, a selector 111 can include first to fourth transistors TR1 to NTR4 and first and second capacitors C1 and C2. Each of the first, third, and fourth transistors TR1, TR3, and NTR4 can be implemented as an n-channel transistor, for example, an n-channel oxide TFT, but embodiments of the present disclosure are not limited thereto. The second transistor PTR2 can be implemented as a p-channel transistor, for example, a p-channel LTPS TFT, but embodiments of the present disclosure are not limited thereto.

Each of the first and third transistors TR1 and TR3 can be turned on in response to a pulse of a dummy gate signal SC2[0] or SC2[n+1] applied via the dummy gate line. When the first transistor TR1 is turned on, the first data line DL1 can be electrically connected to the first gate node ng1. When the second transistor PTR2 is a p-channel transistor, the second transistor PTR2 is turned on when the first selection voltage Von that is applied to the first gate node ng1 is the low voltage L and supplies the gate high voltage VGH to the selection line SL, and is turned off when the first selection voltage Von is the high voltage H.

When the third transistor TR3 is turned on, the third data line DL3 can be electrically connected to the second gate node ng2. The fourth transistor NTR4 is turned on when the second selection voltage Voff that is applied to the second gate node ng2 is the high voltage H and supplies the gate low voltage VGL to the selection line SL, and is turned off when the second selection voltage Voff is the low voltage L.

When the second transistor PTR2 is a p-channel transistor, and the fourth transistor NTR4 is an n-channel transistor, and when the voltages of the first and second selection voltages Von and Voff are the low voltage L, the voltage of the selection signal VSEL is the gate high voltage VGH. When the voltages of the first and second selection voltages Von and Voff are the high voltage H, the voltage of the selection signal VSEL is the gate low voltage VGL. The pixels to which the selection signal VSEL is applied at the gate high voltage VGH can be refresh-driven when the refresh driving signals are applied. The pixels to which the selection signal VSEL is applied at the gate low voltage VGL can be skip-driven because the voltage of the capacitor Cst is maintained in a previous state even when the refresh driving signals are applied.

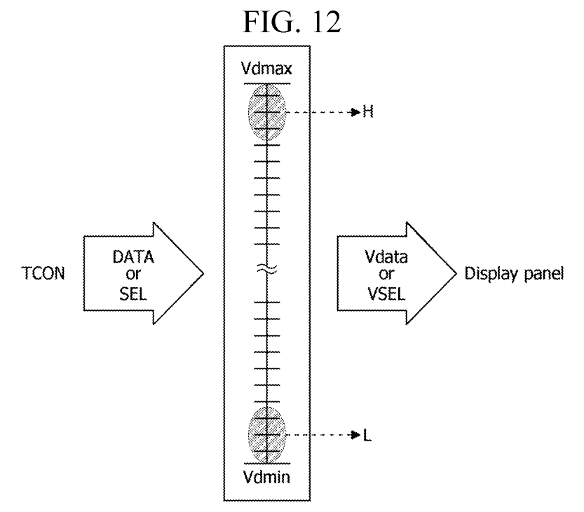

FIG. 12 is a diagram showing an example of selection voltages that are output from the data driver. In FIG. 12, "TCON" represents the timing controller 130.

Referring to FIG. 12, an output voltage or a dynamic voltage range of the data driver 110 is a voltage between a minimum voltage Vdmin and a maximum voltage Vdmax. A lowest grayscale voltage of pixel data can be the minimum voltage Vdmin or a low grayscale voltage close to the minimum voltage Vdmin. A highest grayscale voltage of pixel data can be the maximum voltage Vdmax or a high grayscale voltage close to the maximum voltage Vdmax.

The timing controller TCON transmits pixel data DATA of an input image and selection data SEL as a digital signal voltage to the data driver 110. Each of the channels of the data driver 110 can output the data voltage corresponding to the grayscale value of the pixel data as a gamma compensation voltage within the dynamic voltage range using the DAC.

The data driver 110 can output a voltage corresponding to a logical value of the selection data SEL as a gamma compensation voltage within the dynamic voltage range. For example, the first channel of the data driver 110 can output, as the first selection voltage Von, the high voltage H selected as the maximum voltage Vdmax or the high grayscale voltage close to the maximum voltage Vdmax when first selection data SEL has a first logical value, using the DAC. When the first selection data SEL has a second logical value, the low voltage L selected as the minimum voltage or the low grayscale voltage close to the minimum voltage Vdmin can be output as the first selection voltage Von from the first channel of the data driver 110. The third channel of the data driver 110 can output, as the second selection voltage Voff, the high voltage H selected as the maximum voltage Vdmax or the high grayscale voltage close to the maximum voltage Vdmax when second selection data SEL has the first logical value. When the second selection data SEL has the second logical value, the low voltage L selected as the minimum voltage Vdmin or the low grayscale voltage close to the minimum voltage Vdmin can be output as the second selection voltage Voff from the third channel of the data driver 110. Here, the first logical value is "1" and the second logical value can be "0 (zero)", but embodiments of the present disclosure are not limited thereto.

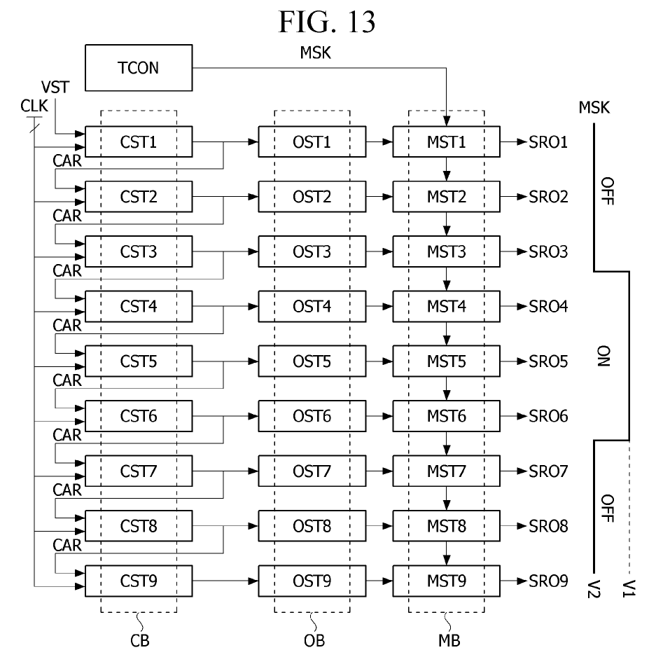

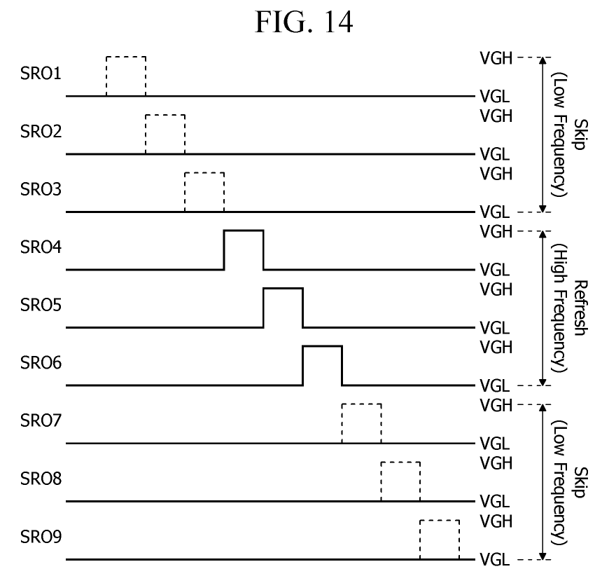

FIGS. 13 and 14 are diagrams showing a device that divides pixel areas, which are different in driving frequency of pixels, in the second direction of the display panel. In FIGS. 13 and 14, "SRO1 to SRO9" can be gate signals that control switch elements connected to a capacitor in a pixel circuit, for example, the first and fourth gate signals SC1 and SC4 shown in FIGS. 3 and 5.

Referring to FIGS. 13 and 14, the timing controller TCON can determine a pixel area that is refresh-driven and a pixel area that is skip-driven, on the basis of a result of analyzing the input image. The timing controller TCON can output a masking signal MSK having different logical values in the pixel area that is refresh-driven and the pixel area that is skip-driven. The masking signal MSK can be provided to the gate driver 120 via the level shifter.

An interval ON in which the masking signal MSK is generated at a voltage V1 having a first logical value is controlled as a pixel area where data is updated in the second direction Y of the display panel 100, for example, a pixel area that is refresh-driven. An interval OFF in which the masking signal MSK is generated at a voltage V2 having a second logical value is controlled as a pixel area where data is not updated in the second direction Y of the display panel 100, for example, a pixel area that is skip-driven.

The gate driver 120 can include a carry signal generator CB, a gate signal generator OB, and a masking processor MB.

The carry signal generator CB includes a plurality of signal transmission parts CST1 to CST9 that are connected in a cascade manner via clock wires to which a clock signal CLK is input and a wire to which a carry signal CAR is input. The carry signal generator CB receives a start signal VST and the clock signal CLK, and sequentially outputs pulses of the carry signals CAR. The carry signal generator CB can be implemented as a shift register, but embodiments of the present disclosure are not limited thereto. The start signal VST is input to a first signal transmission part CST1. The pulses of the carry signals that are sequentially output from the signal transmission parts CST1 to CST9 are input to the gate signal generator OB, and is transmitted as a start signal to the next signal transmission part.

The gate signal generator OB includes a plurality of output parts OST1 to OST9 that are connected to the signal transmission parts of the carry signal generator CB on one-to-one basis. The gate signal generator OB can receive separate start signal and clock signal, but embodiments of the present disclosure are not limited thereto. The output parts OST1 and OST9 can sequentially output the pulses of the gate signals in response to the pulse of the carry signal CAR. A first output part OST1 outputs the pulse of the gate signal in response to the carry signal CAR received from the first signal transmission part CST1. Subsequently, a second output part OST2 outputs the pulse of the gate signal in response to the carry signal CAR received from a second signal transmission part CST2.

The masking processor MB includes a plurality of output control parts MST1 to MST9 that are connected to the output parts OST1 to OST9 of the gate signal generator OB on one-to-one basis. The masking signal MSK can be input in series to the output control parts MST1 to MST9. Each of the output control parts MST1 to MST9 can transmit the pulse of the gate signal to the corresponding gate line of the pixel line in response to the masking signal MSK or can block the output of the pulse of the gate signal and can apply the gate off voltage, for example, the gate low voltage VGL to the corresponding gate line. For example, a first output control part MST1 transmits the pulse of the gate signal input from the first output part OST1 to a gate line connected to sub-pixels of a first pixel line in response to the first logical value of the masking signal MSK. The first output control part MST1 can block the output of the pulse of the gate signal input from the first output part OST1 in response to the second logical value of the masking signal MSK and apply the gate low voltage VGL to the gate line connected to the sub-pixels of the first pixel line to maintain the voltage of the gate line at the gate low voltage VGL in one frame period. A second output control part MST2 transmits the pulse of the gate signal input from the second output part OST2 to a gate line of sub-pixels of a second pixel line in response to the first logical value of the masking signal MSK. The second output control part MST2 can block the output of the pulse of the gate signal input from the second output part OST2 in response to the second logical value of the masking signal MSK and apply the gate low voltage VGL to the gate line connected to the sub-pixels of the second pixel line to maintain the voltage of the gate line at the gate low voltage VGL in one frame period.

According to one or more embodiments of the present disclosure, the display device can be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc. Additionally, the display device according to one or more embodiments of the present disclosure can be applied to organic light emitting lighting devices or inorganic light emitting lighting devices.

The objects to be achieved by the present disclosure, the means for achieving the objects, and effects of the present disclosure described above do not specify essential features of the claims, and thus, the scope of the claims is not limited to the disclosure of the present disclosure.

Although the embodiments of the present disclosure have been described in more detail with reference to the accompanying drawings, the present disclosure is not limited thereto and can be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

What is claimed is:

1. A display device comprising:
a display panel in which a plurality of data lines, a plurality of gate lines, at least one selection line, and a plurality of pixels are disposed;
a data driver electrically connected to the plurality of data lines; and
a selector connected between the data driver and the plurality of pixels, and configured to supply a selection signal to the at least one selection line according to a voltage from the data driver,
wherein a display area of the display panel is divided into a plurality of pixel areas that are driven at different frequencies in a first direction according to a voltage of the selection signal.

2. The display device according to claim 1, further comprising a gate driver electrically connected to the plurality of gate lines, wherein:
the gate driver is configured to supply a plurality of gate signals having different waveforms in the respective pixels to the plurality of gate lines,
the display area of the display panel is divided into a plurality of pixel areas that are driven at different frequencies in a second direction according to a voltage of at least one gate signal among the plurality of gate signals, and
the second direction intersects the first direction.

3. The display device according to claim 1, wherein each of the plurality of pixels includes a plurality of sub-pixels, and
wherein each of the plurality of sub-pixels includes:
a light-emitting element;
a driving element configured to drive the light-emitting element;
a capacitor connected to the driving element; and
at least one switch element that is connected to the capacitor or that is electrically separated from the capacitor in response to the selection signal.

4. The display device according to claim 2, wherein each of the plurality of pixels includes a plurality of sub-pixels, and
wherein each of the plurality of sub-pixels includes:
a light-emitting element;
a driving element configured to drive the light-emitting element;
a capacitor connected to the driving element;
a first-first switch element that is controlled according to the voltage of the selection signal; and
a first-second switch element that is connected in series to the first-first switch element and that is controlled according to a voltage of at least one gate signal among the plurality of gate signals.

5. The display device according to claim 2, wherein the display panel has a plurality of power lines disposed therein, and each of the plurality of pixels includes a plurality of sub-pixels, and
wherein each of the plurality of sub-pixels includes:
a driving transistor including a gate electrode connected to a first node, a first electrode connected to a second node, and a second electrode connected to a third node;
a capacitor connected between a first power line of the plurality of power lines and the first node; and
a light-emitting element including an anode electrode connected to a fourth node and a cathode electrode connected to a second power line of the plurality of power lines.

6. The display device according to claim 5, wherein each of the plurality of sub-pixels further includes:
a first-first switch transistor that is connected between the first node and the third node, and that is turned on in response to a gate on voltage of the selection signal and turned off in response to a gate off voltage of the selection signal; and
a first-second switch transistor that is connected between the first-first switch transistor and the third node, and that is turned on in response to a gate on voltage of a first gate signal among the plurality of gate signals and turned off in response to a gate off voltage of the first gate signal.

7. The display device according to claim 6, wherein each of the plurality of sub-pixels further includes:
a second-first switch transistor that is connected between the first node and a fifth power line of the plurality of power lines to which an initialization voltage is applied, and that is turned on in response to a gate on voltage of the selection signal and turned off in response to a gate off voltage of the selection signal; and
a second-second switch transistor that is connected between the second-first switch transistor and the fifth power line, and that is turned on in response to the gate on voltage of the first gate signal and turned off in response to the gate off voltage of the first gate signal.

8. The display device according to claim 7, wherein each of the plurality of sub-pixels further includes:
a third switch transistor that is connected between the first power line and the second node, and that is turned on in response to a gate on voltage of a fifth gate signal among the gate signals; and
a fourth switch transistor that is connected between the third node and the fourth node, and that is turned on in response to the gate on voltage of the fifth gate signal.

9. The display device according to claim 8, wherein each of the plurality of sub-pixels further includes:
a fifth switch transistor that is connected between the second node and a third power line, and that is turned on in response to a gate on voltage of a third gate signal among the gate signals;
a sixth switch transistor that is connected between the fourth node and a fourth power line of the plurality of power lines, and that is turned on in response to the gate on voltage of the third gate signal; and
a seventh switch transistor that is connected between the data line and the second node, and that is turned on in response to a gate on voltage of a second gate signal among the gate signals.

10. The display device according to claim 2, wherein the display panel has a plurality of power lines disposed therein, and each of the plurality of pixels includes a plurality of sub-pixels, and
wherein each of the plurality of sub-pixels includes:
a driving transistor including a gate electrode connected to a first node, a first electrode connected to a second node, and a second electrode connected to a third node;
a capacitor connected between a first power line of the plurality of power lines and the first node;
a light-emitting element including an anode electrode connected to a fourth node and a cathode electrode connected to a second power line of the plurality of power lines;
a first-first switch transistor that is connected between the first node and the third node, and that is turned on in response to a gate on voltage of the selection signal and turned off in response to a gate off voltage of the selection signal; and
a first-second switch transistor that is connected between the first-first switch transistor and the third node, and that is turned on in response to a gate on voltage of a first gate signal among the plurality of gate signals and turned off in response to a gate off voltage of the first gate signal.

11. The display device according to claim 10, wherein each of the plurality of sub-pixels further includes:
a second-first switch transistor that is connected between the first node and a fifth power line of the plurality of power lines to which an initialization voltage is applied, and that is turned on in response to the gate on voltage of the selection signal and turned off in response to the gate off voltage of the selection signal;
a second switch transistor that is connected between the data line and the second node, and that is turned on in response to a gate on voltage of a second gate signal among the gate signals; and
a third switch transistor that is connected between the first power line and the second node, and that is turned on in response to a gate on voltage of a fourth gate signal among the gate signals.

12. The display device according to claim 11, wherein each of the plurality of sub-pixels further includes:
a fourth switch transistor that is connected between the third node and a fourth node, and that is turned on in response to the gate on voltage of the fourth gate signal;
a fifth switch transistor that is connected between the third node and a third power line of the plurality of power lines, and that is turned on in response to a gate on voltage of a third gate signal among the gate signals; and
a sixth switch transistor that is connected between the fourth node and a fourth power line of the plurality of power lines, and that is turned on in response to the gate on voltage of the third gate signal.

13. The display device according to claim 2, wherein:
a non-display area of the display panel include a dummy gate line electrically connected to the gate driver,
the gate driver is configured to supply a pulse of a dummy gate signal to the dummy gate line, and
the selector is connected to two data lines that are disposed in the non-display area of the display panel and spaced at a predetermined distance, and the dummy gate line.

14. The display device according to claim 13, wherein the data driver includes:
a first channel configured to output a first selection voltage having a voltage selected according to a refresh rate of the plurality of pixel areas and a data voltage corresponding to pixel data of an input image; and
a second channel configured to output a second selection voltage having a voltage selected according to the refresh rate of the pixel areas and a data voltage corresponding to the pixel data of the input image,
wherein:
a first data line of the spaced two data lines is connected to an output terminal of the first channel, and
a second data line of the spaced two data lines is connected to an output terminal of the second channel.

15. The display device according to claim 14, wherein the selector includes:
a first transistor including a gate electrode connected to the dummy gate line, a first electrode connected to the first data line, and a second electrode connected to a first gate node;
a second transistor including a gate electrode connected to the first gate node, a first electrode to which a gate on voltage of the selection signal is applied, and a second electrode connected to the at least one selection line;
a first capacitor connected to the first gate node;
a third transistor including a gate electrode connected to the dummy gate line, a first electrode connected to the second data line, and a second electrode connected to a second gate node;
a fourth transistor including a gate electrode connected to the second gate node, a first electrode to which a gate off voltage of the selection signal is applied, and a second electrode connected to the at least one selection line; and
a second capacitor connected to the second gate node.

16. The display device according to claim 15, wherein channel characteristics of the second transistor and the fourth transistor are different from each other.

17. The display device according to claim 14, wherein:
each of the first selection voltage and the second selection voltage is output as a high voltage or a low voltage from the data driver, and
the high voltage and the low voltage are selected within a voltage range between a maximum voltage and a minimum voltage of the data voltage.

18. A display device comprising:
a display panel in which a plurality of data lines, a plurality of gate lines, at least one selection line, and a plurality of pixels are disposed;
a data driver electrically connected to the plurality of data lines;
a gate driver configured to supply a plurality of gate signals to the plurality of gate lines; and
a selector connected between the data driver and the plurality of pixels, and configured to supply a selection signal to the at least one selection line according to a voltage from the data driver,
wherein a display area of the display panel is divided into a plurality of pixel areas that are driven at different frequencies in a first direction according to a voltage of the selection signal, and that is divided into a plurality of pixel areas that are driven at different frequencies in a second direction intersecting the first direction according to a voltage of at least one of the gate signals.

19. The display device according to claim 18, wherein each of the plurality of pixels includes a plurality of sub-pixels, and
wherein each of the sub-pixels includes:
a light-emitting element;
a driving element configured to drive the light-emitting element;
a capacitor connected to the driving element; and
first-first and first-second switch transistors connected in series to the capacitor,
wherein:
the first-first switch transistor is turned on in response to the selection signal, and
the first-second switch transistor is turned on in response to at least one of the gate signals.

20. A method for driving a display device, the method comprising:
generating a selection signal having a voltage selected according to a refresh rate of pixel areas divided in a first direction;
generating a gate signal having a voltage selected according to a refresh rate of pixel areas divided in a second direction intersecting the first direction; and
controlling a driving frequency of the pixel areas divided in the first direction and the second direction by applying the selection signal and the gate signal to pixels in the respective pixel areas.
